(19) United States
(12) Patent Application Publication
(10) Pub. No.: US 2026/0060170 A1
(43) Pub. Date: Mar. 5, 2026

(54) GOLF COURSE MANAGEMENT SYSTEM

(71) Applicant: Textron Inc., Providence, RI (US)

(72) Inventor: Brian Wanta, North Augusta, SC (US)

(73) Assignee: Textron Inc., Providence, RI (US)

(21) Appl. No.: 18/817,436

(22) Filed: Aug. 28, 2024

(51) Int. Cl. A01D 34/00; A01D 101/00; G05D 1/648

(52) U.S. Cl. CPC A01D 34/008; G05D 1/6484; A01D 2101/00

(57) ABSTRACT

A method includes (a) receiving course data identifying a first zone, a second zone, and a third zone within a golf course, (b) generating time prediction data including predicted work times indicating a predicted amount of time required for a mower to mow one of the zones, (c) receiving a set of desired mowing parameters indicating that a first mower and a second mower are available for maintenance of the golf course, (d) generating a first route assignment for the first mower and a second route assignment for the second mower based on the course data and the time prediction data, and (e) providing a graphical user interface including instructions for an operator to complete the first route assignment using the first mower. The first route assignment includes mowing the first zone and the second zone. The second route assignment includes mowing the third zone.

### BACKGROUND

The present disclosure relates generally to outdoor equipment, such as mowers or golf cars. More specifically, the present disclosure relates to determining a route for a mower.

Mowers are used to maintain vegetation (e.g., grass, clover, weeds, etc.) at a desired height. Golf courses have large areas of vegetation that require regular maintenance, often at different heights and with different mowing patterns. To achieve this, golf courses utilize fleets of mowers that are capable of mowing the entire area of the golf course in a short period of time.

### SUMMARY

One embodiment relates to a method of maintaining a golf course including (a) receiving course data identifying a first zone, a second zone, and a third zone within the golf course, (b) generating time prediction data for mowers associated with the golf course, the time prediction data including predicted work times indicating a predicted amount of time required for one of the mowers to mow one of the zones, (c) receiving a set of desired mowing parameters indicating that a first mower and a second mower of the mowers are available for maintenance of the golf course, (d) generating a first route assignment for the first mower and a second route assignment for the second mower based on the course data and the time prediction data for the first mower and the second mower, and (e) providing a graphical user interface on a user device, the graphical user interface including instructions for an operator to complete the first route assignment using the first mower. The first route assignment indicates that the first mower should mow the first zone and the second zone. The second route assignment indicates that the second mower should mow the third zone.

Another embodiment relates to a method of maintaining a golf course. The method includes (a) receiving course data identifying zones within the golf course, the zones including a first zone and a second zone, (b) generating time prediction data for mowers associated with the golf course, the time prediction data including predicted travel times, each predicted travel time indicating a predicted amount of time required for one of the mowers to travel between two of the zones, (c) generating a route assignment for a first mower of the mowers based on the course data and the time prediction data for the first mower, and (d) providing a graphical user interface on a user device, the graphical user interface including instructions for an operator to complete the route assignment using the first mower. The route assignment indicates that the first mower should mow the first zone and the second zone.

Still another embodiment relates to a golf course management system including a first mower, a second mower, a user device, and a non-transitory computer-readable medium. The medium has instructions stored thereon that, when executed by one or more processors, cause the one or more processors to (a) receive course data identifying zones within a golf course, the zones including a first zone, a second zone, and a third zone, (b) generate time prediction data including predicted work times, each predicted work time indicating a predicted amount of time required for the first mower or the second mower to mow one of the zones, (c) generate a first route assignment for the first mower and a second route assignment for the second mower based on the course data and the time prediction data, and (d) control the user device to provide a graphical user interface including instructions for an operator of the first mower to complete the first route assignment. The first route assignment indicates that the first mower should mow the first zone and the second zone. The second route assignment indicates that the second mower should mow the third zone.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1A is a perspective view of a vehicle, according to an exemplary embodiment.

FIG. 1B is a perspective view of a vehicle, according to another exemplary embodiment.

FIG. 2 is a schematic block diagram of the vehicle of FIG. 1A, according to an exemplary embodiment.

FIG. 3 is a is schematic block diagram of a site monitoring and control system including a plurality of the vehicles of FIG. 1A, according to an exemplary embodiment.

FIG. 4 is flowchart illustrating a golf course management method, according to an exemplary embodiment.

FIG. 5 is a map of a golf course, according to an exemplary embodiment.

FIG. 6 is a screenshot of a graphical user interface (GUI) illustrating a route assignment for one of the vehicles of FIG. 1A, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a golf course management system is shown according to an exemplary embodiment. The golf course management system includes multiple mowers and a control system that manages operation of the mowers. The system may be used to maintain (e.g., mow, rake, etc.) various parts of a golf course or other operating area. The mowers are regularly deployed to maintain these areas at the beginning of a day, and it is advantageous for the mowers to complete this maintenance as quickly as possible (e.g., in order to accommodate early tee times).

In order to accomplish this, the system monitors operation of the mowers throughout a training period to generate time prediction data predicting long each mower in the fleet requires to perform certain tasks (e.g., mowing a certain hole) and to travel between the different areas. Using this time prediction data, the system is able to predict how long a mower will take to complete a proposed route. At the beginning of a day, a manager of the golf course indicates which mowers are available for use and which maintenance tasks should be completed that day (e.g., which holes should be mowed, which bunkers should be raked, etc.). Based on the time prediction data, the system generates route assignments for each available mower that minimize the overall time required for the system to complete the maintenance. The system provides these route assignments to the operators of the mowers through a graphical user interface. The graphical user interface may update in real-time as the operator navigates the mower and completes the tasks.

Other systems manage fleets of mowers manually. Each mower is assigned an initial starting hole through a job board. When that task is completed, and the operator selects their next hole themselves, often moving to the next closest unoccupied hole. This results in the mowers leapfrogging themselves to reach the next unoccupied hole without any regard for the spacing of the holes. Additionally, operators will sometimes be reluctant to mow large areas, as it may be less enjoyable to spend a long period of time in the same area. By predetermining the route of each mower, the golf course management system described herein eliminates these inefficiencies.

### Overall Vehicle

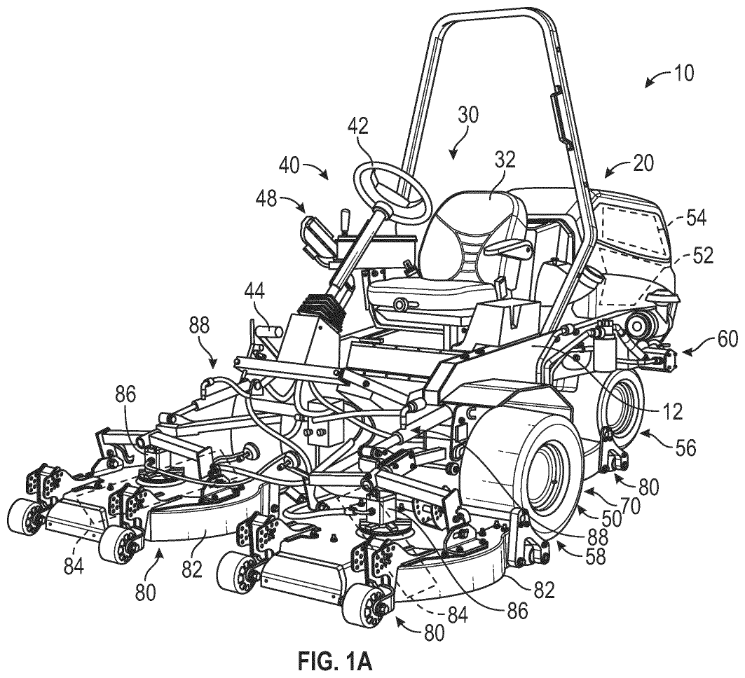

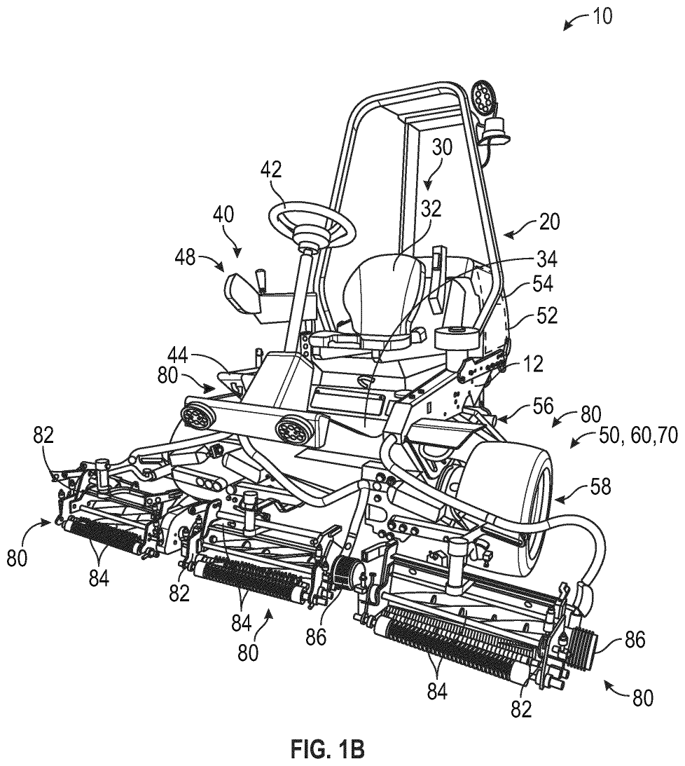

As shown in FIG. 1A-3, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a series of implements, mower assemblies, or cutting units, shown as mower decks 80; one or more sensors, shown as sensors 90; and a vehicle control system, shown as vehicle controller 100, coupled to the operator controls 40, the driveline 50, the suspension system 60, the braking system 70, the mower decks 80, and the sensors 90. In other embodiments, the vehicle 10 includes more or fewer components.

According to an exemplary embodiment, the vehicle 10 is an off-road machine or vehicle. As shown in FIGS. 1A and 1B, the vehicle 10 is configured as a mower (e.g., a lawnmower, a turf mower, a push mower, a ride-on mower, a stand-on mower, or another type of mower). In other embodiments, the off-road machine or vehicle is a lightweight or recreational machine or vehicle such as a golf cart, golf cars, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiments shown in FIGS. 1A and 1B, the occupant seating area 30 includes a single seat, shown as driver seat 32. In some embodiments, the occupant seating area 30 includes additional seats (e.g., a passenger seat, an additional row of seats, etc.). According to the exemplary embodiments shown in FIGS. 1A and 1B, the driver seat 32 is laterally centered on the body 20 and facing forward. In some embodiments, the driver seat 32 is facing rearward or otherwise positioned. In some embodiments, the occupant seating area 30 is omitted (e.g., the vehicle 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

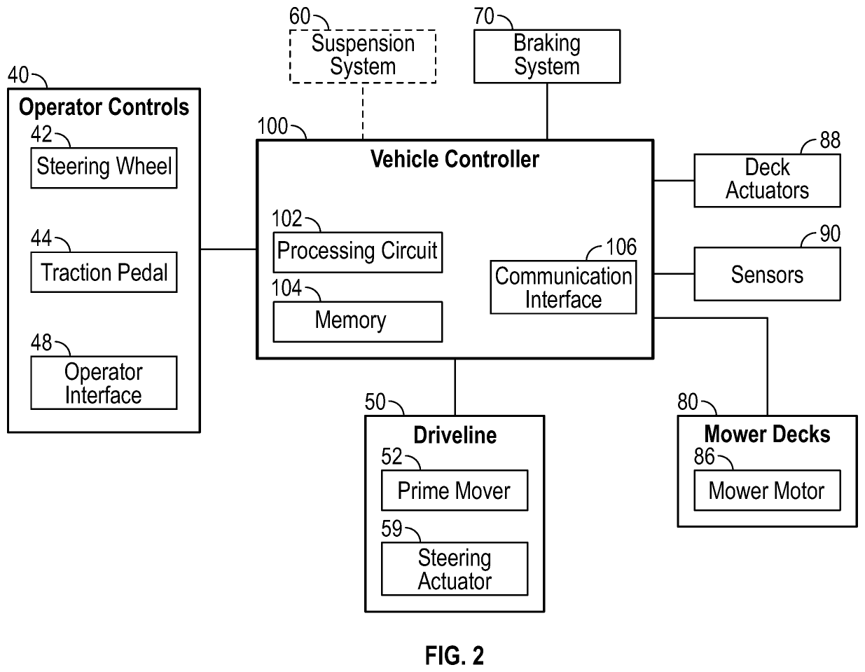

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a mower deck 80, etc.). As shown in FIGS. 1A, 1B, and 2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The steering wheel 42 may be used by an operator to indicate a desired steering direction of the vehicle 10. The traction pedal 44 may be used to control the speed and direction of travel of the vehicle 10. By way of example, pressing the traction pedal 44 in a first direction may cause the driveline 50 to move the vehicle 10 forward, and pressing the traction pedal 44 in an opposing section direction may cause the driveline 50 to move the vehicle 10 rearward. Returning the traction pedal 44 to a middle or neutral position may cause the braking system 70 and/or the driveline 50 to slow or stop the vehicle 10 or to hold the vehicle 10 in place. Alternatively, the operator interface 48 may include a pair of handles that act as a steering interface and control the driveline 50 in a zero-turn configuration (e.g., a left joystick to control the left side of the driveline 50 and a right joystick to control a right side of the driveline 50).

The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1A, 1B, and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiments shown in FIGS. 1A and 1B, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., based on an input from the steering wheel 42 and using a steering actuator 59 that controls the orientation of one or more wheels). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

Referring to FIGS. 1A and 1B, the vehicle 10 includes a series of mower decks 80 (e.g., cutting units). Each mower deck 80 includes a deck, housing, or enclosure, shown as housing 82, and a cutting element 84 (e.g., a blade, a flail, a reel, etc.) movably coupled to the housing 82. Specifically, the vehicle of FIG. 1A illustrates a vehicle 10 in which the mower decks 80 each include a cutting element 84 configured as a blade that rotates about a substantially vertical axis. FIG. 1B illustrates an alternative configuration in which the cutting elements 84 are configured as reels that each rotate about a substantially horizontal axis. Except as otherwise specified, the vehicle 10 of FIG. 1A may be substantially similar to the vehicle 10 of FIG. 1B.

Accordingly, an description of the vehicle 10 of FIG. 1A may apply to the vehicle 10 of FIG. 1B, except as otherwise specified.

Referring to FIGS. 1A and 1B, the housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take off).

The vehicle 10 includes a series of linear actuators or height adjustment actuators, shown as deck actuators 88, each coupled to the frame 12 and to one or more of the mower decks 80.

The deck actuators 88 permit control over a height of the corresponding mower deck 80 relative to the frame 12. The deck actuators 88 may set a cutting height of the mower deck 80. The cutting height represents a final height of vegetation that is trimmed by the mower deck 80. The deck actuators 88 may move the mower deck 80 to a travel position above the cutting height, in which the mower deck 80 is moved out of engagement with the vegetation and the ground surface. The travel position may be used when the vehicle 10 is traveling between job sites and/or the user does not wish to be trimming vegetation.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.).

According to an exemplary embodiment, the vehicle controller 100 is coupled to (e.g., communicably coupled to) components of the operator controls 40 (e.g., the steering wheel 42, the traction pedal 44, the brake 46, the operator interface 48, etc.), components of the driveline 50 (e.g., the prime mover 52), components of the braking system 70, the mower decks 80, the deck actuators 88, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitate communications (e.g., wired or wireless communications) between the vehicle 10 and other devices (e.g., other vehicles 10, the user sensors 220, the user portal 230, the remote systems 240, etc.). By way of example, the communications interface 130 may be configured to employ one or more types of wireless communications protocols including Bluetooth, Wi-Fi, radio, cellular, and/or other suitable wireless communications protocols.

### Site Monitoring and Control System

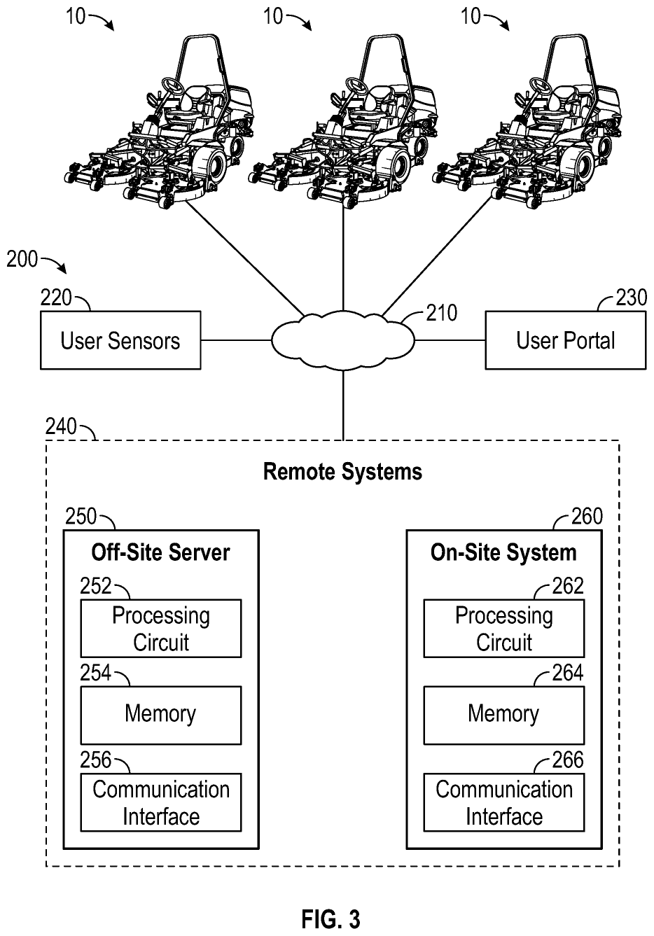

As shown in FIG. 3, a monitoring and control system or golf course management system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210 (e.g., using the communication interface 106).

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Golf Course Management Method

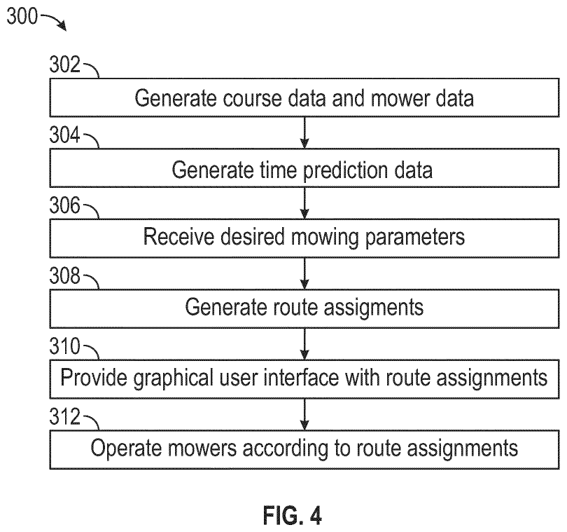

Referring to FIG. 4, a golf course management method is shown as a method 300, according to an exemplary embodiment. The method 300 may be used to manage one or more of the vehicles 10 to accomplish a desired task. In some embodiments, the method 300 facilitates vegetation management (e.g., mowing) or other maintenance tasks throughout a golf course. By way of example, the method 300 may be utilized to generate route assignments for vehicles 10, based on which of the vehicles 10 are available for use at a given time. A golf course may have various areas or zones (e.g., holes), and each zone may take a certain amount of time for a given vehicle 10 to mow. Additionally, each vehicle 10 may take a certain amount of time to travel between different zones. The method 300 may facilitate mowing all of the desired zones in a minimum amount of time for a given group of available vehicles 10.

The method 300 includes various processes. For ease of description, the processes of the method 300 are described as being performed by the remote systems 240. It should be understood, however, that the processes may be performed by any component of the control system 200. By way of example, the processes of the method 300 may be performed by the vehicle controllers 100 and/or the remote system 240. In some embodiments, one or more processes are performed wholly by one component of the control system 200 (e.g., an off-site server 250 performs the entire process). In some embodiments, one or more processes are distributed across multiple components (e.g., a portion of the processing is performed by a vehicle controller 100, and another portion of the processing is performed by an off-site server 250).

### Generating Course Data and Mower Data

In step 302 of the method 300, characteristic data is generated and stored. The characteristic data may be stored, for example, in the memory 254 of an off-site server 250 and/or the memory 264 of an on-site system 260. The characteristic data describes a characteristics of the system to be managed according to the method 300. Specifically, the characteristic data may include course data and mower data. The course data may describe characteristics of an operating area, such as a golf course, that will be maintained using the method 300. The mower data may describe characteristics of the vehicles 10 that are used throughout the method 300. By way of example, the mower data may describe characteristics of a fleet of mowers owned by or otherwise associated with a given golf course.

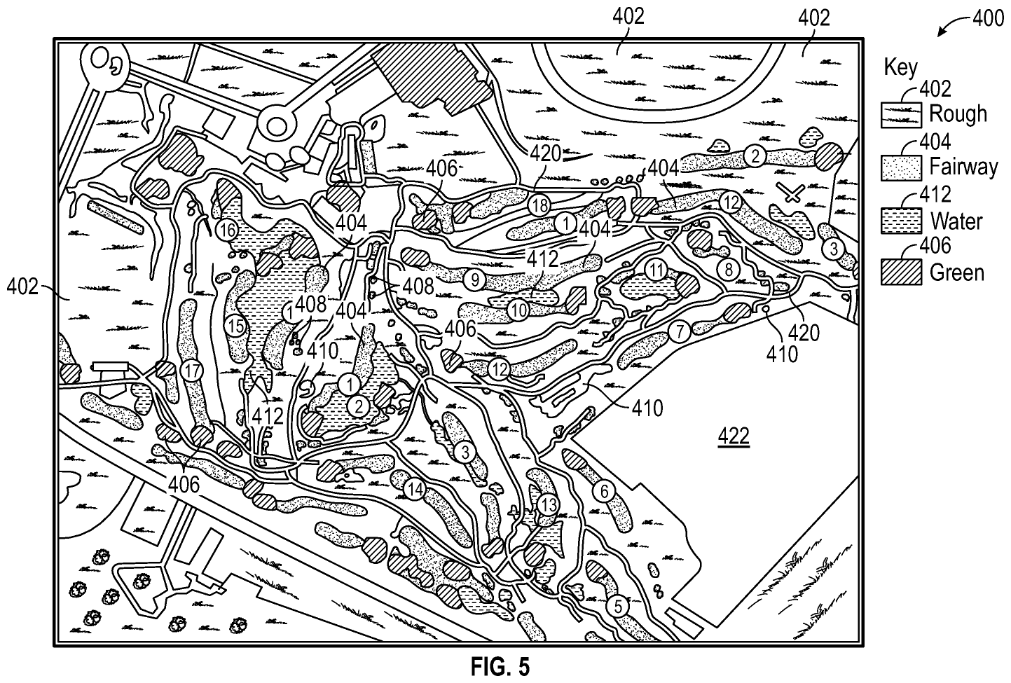

In some embodiments, the course data includes map data defining various boundaries within the operating area. FIG. 5 illustrates a graphical representation of map data, shown as a map 400, that illustrates an operating area. As shown, the operating area illustrated by the map 400 is a golf course. In other embodiments, the method 300 is utilized with another type of operating area (e.g., a soccer field, a baseball diamond, a dog park, a garden, a residential yard, etc.). While the map 400 is shown graphically for ease of illustration, the map data associated be defined and stored without a graphical illustration (e.g., as a table or other group of data points).

As shown in FIG. 5, the map 400 includes a series of zones, areas, sections, sectors, or regions that each represent a portion of the operating area. Each zone may have an associated shape, size, and location such that the boundaries of the zones are predetermined and stored in the map data (e.g., as a predefined geofence). Based on the map data, the remote systems 240 may determine which zone contains a specific coordinate. By way of example, a sensor 90 may supply a coordinate representing a current position of a vehicle 10, and the remote system 240 may use the map data and coordinate to determine in which zone the vehicle 10 is currently present. Accordingly, the remote systems 240 may use the map data to determine the relative locations and distance between each zone.

Each zone may be associated with one or more properties, and these corresponding physical properties may be stored in the map data. These properties may represent desired physical properties that a manager of the system wishes to maintain within the zone. By way of example, the map data may include surface type data indicating a material that is desired on the ground within the zone (e.g., vegetation, sand, pavement, etc.). By way of example, the map data may include vegetation type data indicating a type or species of vegetation that is desired for the zone (e.g., grasses, such as Bermuda Grass, Kentucky Bluegrass, Zoysia, Fescue, Poa Annua, etc.). By way of example, the map data may include vegetation height data indicating a desired height of vegetation within the zone. By way of example, the map data may include mowing pattern data indicating a desired mowing or orientation for vegetation within the area. By way of example, the map data may include permission data indicating whether or not a vehicle 10 has permission to access a zone. By way of example, the map data may include topographic data indicating an elevation profile of the zone (e.g., the elevation at multiple points within the zone, the contour of the ground surface throughout the zone, etc.).

FIG. 5 illustrates an example of a map 400 of an operating area, shown as a golf course. The map 400 includes eighteen holes, each identified with a corresponding number (e.g., a circled 1 indicates the first hole, a circled 18 indicates the last hole, etc.). The map 400 includes a series of a first zones, shown as rough 402, each containing grass that is relatively tall. The map 400 includes a series of second zones, shown as fairways 404, each containing grass that is shorter than the grass of the rough 402. The map 400 includes a series of third zones, shown as greens 406, containing grass that is shorter than the grass of the fairway 404. The greens 406 may each contain a hole intended to receive a golf ball. The map 400 includes a series of fourth zones, shown as tee boxes 408, containing grass that is shorter than the grass of the rough 402. The tee boxes 408 may represent areas where a golf ball is initially staged when playing a hole, and the tee boxes 408 may be offset at different distances from the hole (e.g., corresponding to different handicaps). The map data may include vegetation height data, mowing pattern data, and vegetation type data for the grasses within the rough 402, the fairway 404, the greens 406, the tee boxes 408, and/or other zones within the map.

The map 400 includes a series of fifth zones or obstacles, shown as bunkers 410 or sand traps, containing a granular material, such as sand. The map data may indicate that the bunkers 410 should not be mowed (e.g., the vehicle 10 is not permitted to enter the bunkers 410). The map 400 includes a series of sixth zones, obstacles, or bodies of water (e.g., ponds, streams, lakes, etc.), shown as water zones 412. The map data may indicate that a vehicle 10 is not permitted to enter the water zones 412.

The map 400 includes a series of seventh zones or cart areas, shown as cart paths 420, extending throughout various areas of the map 400. The cart paths 420 may be coated with a durable road material (e.g., pavement, asphalt, concrete, gravel, etc.) different from the grass of the surrounding zones, or otherwise configured to facilitate repeated travel by the vehicle 10 or other vehicles (e.g., golf carts, UTVs, etc.). The map data may include permission data indicating that certain vehicles may travel along the cart paths 420 (e.g., preventing the vehicles from moving off of the cart paths 420, preventing the vehicles from moving into the adjacent rough 402, etc.). The map 400 includes an eighth zone, shown as parking lot 422, having a section of road material intended to support multiple vehicles. The parking lot 422 may be contiguous with the cart path 420.

In some embodiments, the map 400 includes other types of zones. By way of example, the map 400 may include one or more zones representing a building or other structure (e.g., a clubhouse, a pro shop, a restaurant, a garage, etc.). The map data may include permission data that limits or prevents the vehicle 10 from traveling into the building. By way of another example, the map 400 may include one or more tree zones containing trees, bushes, or other vegetation that may act as an obstacle. By way of another example, the map 400 may include fescue zones containing grass that is longer than the grass of the rough 402.

In some embodiments, the mower data includes a roster, list, or database of vehicles 10 (e.g., a mower data database) that may be associated with (e.g., available for use with) an operating area. By way of example, the database may include all vehicles 10 owned by a company managing a golf course, or all vehicles 10 on site at a golf course. The database of vehicles 10 may include vehicles 10 that are immediately available, as well as vehicles that are temporarily unavailable (e.g., due to requiring maintenance). In addition, the database may include a current status of each vehicle 10 (e.g., available, in use, undergoing maintenance, etc.).

In some embodiments, the database includes identifying information for each vehicle 10 in the database. By way of example, the database may include a serial number, identification number, or other identifier that uniquely identifies each vehicle 10. By way of another example, the database may include a model number of each vehicle 10. The model number may be provided by a manufacturer and may denote a particular product configuration sold by the manufacturer. The database may include multiple vehicles 10 having the same model number.

The mower data may include information regarding the capabilities of each vehicle 10 in the database. By way of example, the mower data may indicate a type or category of the vehicle 10 (e.g., a riding mower, a walk behind mower, whether the vehicle 10 includes reels or blades, etc.). By way of another example, the mower data may include a cutting width of each vehicle 10 (e.g., 36 inches, 48 inches, 60 inches, 72 inches, etc.) that the vehicle 10 is capable of cutting in one pass. By way of another example, the mower data may include a cutting height range (e.g., 0.3″ to 1″, 1″ to 4″, etc.) that the vehicle 10 is capable of achieving with adjustment (e.g., manual adjustment or adjustment using a deck actuator 88). By way of another example, the mower data may include a maximum travel speed (e.g., 10 mph, 20 mph, etc.) that each vehicle 10 is capable of achieving (e.g., when self-propelled on a flat surface).

In some embodiments, the mower data includes compatibility data indicating which types of zones each vehicle 10 is capable of mowing. The compatibility data my indicate (a) which types of zones a vehicle 10 is capable of mowing currently, (b) which types of zones a vehicle 10 is capable of mowing after some form of adjustment, and/or (c) which types of zones a vehicle 10 is incapable of mowing. By way of example, the compatibility data may indicate that a vehicle 10 is currently capable of mowing greens (e.g., the greens 406), could be capable of mowing a fairway (e.g., the fairway 404) with adjustment (e.g., by adjusting a cutting height of a mower deck), and is incapable of mowing rough (e.g., the rough 402).

In some embodiments, the remote systems 240 determine the compatibility data based on the course data and other mower data. The course data may include the desired properties of each zone on the map 400, and the remote systems 240 may compare the desired properties with the capabilities of each vehicle 10 stored in the mower data. By way of example, the course data may include the vegetation height of each type of zone, and the remote systems 240 may compare the vegetation height of each zone with the cutting height range of each vehicle 10. If the vegetation height of the zone falls within the cutting height range for a vehicle 10, the remote system 240 may determine that the vehicle 10 is capable of cutting that zone. If the vegetation height of the zone falls outside of the cutting height range for a vehicle 10, the remote system 240 may determine that the vehicle 10 is incapable of cutting that zone. By way of another example, the course data may include vegetation type data for each zone and data indicating whether a given vegetation type requires a specific type of cutting implement (e.g., a reel, a blade, etc.). If the required type of cutting implement matches the cutting implement of a vehicle 10, the remote system 240 may determine that the vehicle 10 is capable of cutting that zone. If the required type of cutting implement does not match the cutting implement of a vehicle 10, the remote system 240 may determine that the vehicle 10 is incapable of cutting that zone.

In some embodiments, the database groups the vehicles 10 into groups or categories. A vehicle 10 may belong to multiple categories. By grouping the vehicles 10 into categories, a user may quickly and easily identify a subset of vehicles 10 suitable for a particular task. By way of example, vehicles 10 with similar or identical model numbers may be grouped into corresponding model groups. By way of another example, vehicles 10 with similar capabilities may be grouped into corresponding capability categories (e.g., reel vs blade mowers, mowers having a cutting width over 48 inches, mowers capable of cutting a particular zone).

In some embodiments, the characteristic data (e.g., the course data and/or the mower data) is manually generated (e.g., entered) by a user. By way of example, the user portal 230 may provide a user with a graphical user interface (GUI) showing the operating area. The user portal 230 may utilize existing map data of the operating area (e.g., provided by a third party map service). The existing map data may provide include a graphical representation of the operating area, and may include corresponding topographical data. Through the GUI of the user portal 230, the user may define the boundaries one or more zones on the graphical representation of the operating area. By way of example, the user may draw the boundaries using a mouse or touchscreen display. The user may then manually define one or more properties of each zone (e.g., surface type data, vegetation type data, vegetation height data, mowing pattern data, permission data, topographic data, etc.).

By way of another example, the user portal 230 may provide a user with a GUI through which a user can manually enter the mower data. By selecting “add a mower” on the GUI, the user may add a new vehicle 10 to the mower data, along with information regarding the capabilities of the vehicle 10 (e.g., through a series of editable text fields).

In some embodiments, the characteristic data is generated based on data collected during operation of a vehicle 10 (e.g., a sample mowing operation is performed to train the map 400). By way of example, a user may manually operate the vehicle 10 to perform a mowing operation within the operating area. This mowing operation may represent a model mowing operation that a user desires to replicate or imitate in the future. While the mowing operation is performed, the vehicle controller 100 may record the data provided by the sensors 90 and the commands sent to components of the vehicle 10. This recorded data may be correlated and used to generate the map data.

In one example, the user trains a portion of the map 400 including a fairway 404. Prior to beginning the mowing operation, the user sets the cutting height of the mower deck 80 to correspond to the desired length of the grass within the fairway 404. The user navigates the vehicle 10 to the fairway 404. The user may manually initiate a training period, or the vehicle controller 100 may initiate the training period automatically. The user then manually operates the vehicle 10 to cut the grass as desired and concludes the training period. Throughout the training period, the vehicle controller 100 may monitor and record data from the sensors 90 and commands sent to the components of the vehicle 10.

The location of the vehicle 10 may be provided by a sensor 90 and correlated to the rest of the recorded data to generate the map 400. By way of example, the vehicle controller 100 may monitor the speed and heading of the vehicle 10 at each location to generate the mowing pattern data. By way of another example, the vehicle controller 100 may monitor the type of surface below the vehicle 10 (e.g., based on image data from a camera) at each location to determine the surface type data and vegetation type data). By way of another example, the vehicle controller 100 may monitor the cutting height of the mower deck 80 at each location to determine the vegetation height data. By way of another example, the vehicle controller 100 may monitor the elevation of the vehicle 10 at each location to determine the topographic data.

By way of another example, the vehicle controller 100 may monitor which locations the vehicle 10 enters while the mower deck 80 is active (e.g., turned on, cutting, etc.) to determine the boundaries of the fairway 404 and/or the permission data. In one such example, the vehicle 10 travels throughout a range of locations having an outer perimeter and an inner perimeter. The vehicle controller 100 may determine that the outer and inner perimeters represent the boundaries of the fairway 404 (e.g., areas cut by the vehicle 10 during the training period are considered part of the fairway 404, and areas that were not cut by the vehicle 10 during the training period are considered to be other zones). The vehicle controller 100 may determine that the inner perimeter defines a hazard, such as a bunker 410 or a water zone 412, and update the permission data to prevent the vehicle 10 from traveling into the hazard in the future.

### Generating Time Prediction Data

In step 304 of the method, time prediction data are generated. The time prediction data may represent a prediction of an amount of time that is required to complete certain actions. The time prediction data may include work time, which is the predicted amount of time required to complete a task (e.g., mowing a zone, raking a bunker, etc.). The time prediction data may include travel time, which is the predicted amount of time required to travel between two locations. The time prediction data may include reconfiguration time, which is the predicted amount of time required to reconfigure a vehicle 10. The time prediction data may be utilized to predict a total time required for a vehicle 10 to complete a particular route (e.g., including traveling between different zones and completing tasks associated with the zones).

In some embodiments, the time prediction data are generated through training. The training may include operating the vehicles 10 throughout a training period. By way of example, the vehicles 10 may be used to mow or otherwise maintain a golf course throughout a training period (e.g., days, weeks, months, years, etc.). During the training period, the sensors 90 may be utilized to monitor the locations of each vehicle 10 while the vehicles 10 are operated. Based on the geofences associated with the map 400, the remote systems 240 may determine which actions are being performed by each vehicle and how long the action takes.

By way of example, the remote systems 240 may utilize location data from a sensor 90 associated with a vehicle 10 to determine a work time associated with mowing a particular zone (e.g., a green 406). Using the location data, the remote systems 240 may determine when the vehicle 10 enters a geofence associated with the zone. The remote system 240 may begin a timer in response to such a determination, and the remote system 240 may terminate the timer when the vehicle 10 exits the geofence. This elapsed time may be considered the work time required for that vehicle to mow that zone.

In some embodiments, the remote systems 240 differentiate between work time measurements for different mowing patterns within a given zone. By way of example, a vehicle 10 may mow a zone with a first mowing pattern (e.g., north/south lines) on a first day, then may mow the same zone with a second mowing pattern (e.g., east/west lines) on a second day. Based on the mowing pattern, a vehicle 10 may be required to turn more or less often, and may be required to take more or fewer passes to finish mowing the zone, impacting the required work time. Accordingly, the remote systems 240 may increase the accuracy of predicted work times in the future by storing different work times based on the mowing pattern within a given zone.

By way of another example, the remote systems 240 may utilize location data from a sensor 90 associated with a vehicle 10 to determine a travel time associated with moving between two zones (e.g., between two greens 406). Using the location data, the remote systems 240 may determine when the vehicle 10 exits a geofence associated with a first zone and when the vehicle enters a geofence associated with a second zone. The elapsed time between these two events may be considered the travel time required for that vehicle 10 to move between those two zones. The vehicle 10 may be self-powered when traveling between two zones (e.g., driven by the prime mover 52) and/or the vehicle 10 may be transported by another vehicle (e.g., on a trailer pulled behind a truck).

By way of another example, the remote systems 240 may utilize data from one or more sensors 90 associated with a vehicle 10 to determine a reconfiguration time associated with reconfiguring the vehicle 10 to operate within a different type of zone. In one such example, a vehicle 10 may require a cutting height adjustment to permit operation in different types of zones. Such a cutting height adjustment may be performed by the vehicle 10 (e.g., by a deck actuator 88) or manually. Using data from a sensor 90, the remote systems 240 may determine when a vehicle 10 starts and finishes a cutting height adjustment required for operation within a given type of zone. The elapsed time may be considered a reconfiguration time required to change between the cutting height for the first type of zone and the cutting height for the second type of zone.

A training period may be selected that is sufficiently long for the vehicles 10 in the system to each perform mowing within a variety of zones and for the vehicles 10 to move between a variety of different zones. By way of example, the same golf course may be mowed over multiple days, weeks, months, or years while varying the zones assigned to each vehicle 10 and the paths traveled by each vehicle 10. This strategy may provide a variety of training data for each vehicle 10 in order to provide a clear picture of the length of time required by each vehicle 10 to perform any task throughout the golf course. Work times, travel times, and/or reconfiguration times may be assumed to be similar for similar vehicles 10 (e.g., multiple vehicles 10 having the same model number, vehicles 10 within a common group, etc.). Accordingly, a work time measurement, a travel time measurement, or a reconfiguration time measurement for a given vehicle may be applied to that vehicle 10 and all other vehicles 10 identified as being similar to that vehicle 10.

Additionally, throughout the training period, the work time for a vehicle 10 within a given zone or the travel time for a vehicle 10 along a given route may be measured multiple times.

When multiple measurements are available, the measurements may be averaged to provide a more accurate prediction of a work time, travel time, and/or reconfiguration time. By way of example, a vehicle 10 may be used to mow a specific green 406 several times in consecutive weeks. The work time for the vehicle 10 to mow that green 406 may be considered the average of the measured work times. By way of another example, a vehicle 10 may travel along the same route between two zones multiple times in a given day, and the travel time for that route may be considered the average of the measured travel times. In this way, the time prediction data may be continuously updated for improved accuracy.

In some embodiments, the travel time for a vehicle along a given route or path is determined based on a predicted travel speed of the vehicle 10 and the length of the route. By way of example, the travel speed of the vehicle 10 may be predicted based on an average speed of the vehicle 10 while the vehicle 10 is traveling during the training period. By way of another example, the travel speed of the vehicle 10 may be predicted based on the mower data generated in step 302 (e.g., a manufacturer-specified travel speed of the vehicle 10). The remote systems 240 may calculate a length of a route between two zones based on the map data (e.g., the distance between two coordinates on the map 400). By dividing the length of the path by the predicted travel speed of the vehicle 10, the remote systems 240 may calculate a travel time for a given path segment.

In some embodiments, the time prediction data includes work times for a user to perform a task without the use of a vehicle 10. By way of example, the remote systems 240 may calculate a work time required for a user to rake a bunker 410. The bunkers 410 may be raked by users that utilize vehicles 10 to mow nearby roughs 402, fairways 404, greens 406, tee boxes 408, etc. While a vehicle 10 may not be required when raking a bunker 410, a vehicle 10 may sit idle while the corresponding user performs the raking. Accordingly, this work time still occupies the vehicle 10. In some embodiments, the remote systems 240 calculate a work time for raking a bunker as the amount of time that the vehicle 10 sits stationary while nearby a bunker 410. In other embodiments, the work time for raking a bunker 410 is manually measured and provided to the remote systems 240 (e.g., through a user portal 230).

### Receiving Desired Mowing Parameters

In step 306 of the method 300, desired mowing parameters are received by the remote systems 240. By way of example, a user, such as a golf course manager, may provide a set of desired mowing parameters at the beginning of a given day (e.g., through a user portal 230). The desired mowing parameters may indicate how exactly the user would like the golf course to be maintained as well as the resources available to perform the maintenance.

The desired mowing parameters may include an indication of which zones should be mowed that day. By way of example, a golf course manager may indicate that the entire course should be mowed that day (e.g., all of the roughs 402, fairways 404, greens 406, tee boxes 408, etc.). By way of another example, the golf course manager may indicate that a subset of the holes should be mowed that day (e.g., holes 1-9 are mowed on Monday, and holes 10-18 are mowed on Tuesday, etc.). By way of another example, the golf course manager may indicate that a certain type of zone should be mowed (e.g., all of the greens 406 should be mowed). By way of another example, the golf course manager may select a specific subset of zones to be mowed. In some embodiments, the desired mowing parameters include an indication of which bunkers 410 should be raked that day.

The desired mowing parameters may include an indication of a desired mowing pattern within each zone. By way of example, the golf course manager may specify that all greens should be mowed using north/south lines, and all fairways should be mowed using east/west lines. By way of another example, the golf course manager may specify that holes 1-9 should be mowed using north/south lines.

The desired mowing parameters may include an indication of which vehicles 10 are available to perform maintenance (e.g., mowing) that day. The available vehicles 10 may be a subset or all of the vehicles 10 identified in the mower data generated in step 302. By way of example, the available vehicles 10 may include all of the vehicles 10 associated with the golf course. By way of another example, the available vehicles 10 may exclude vehicles 10 that are currently undergoing maintenance.

The desired mowing parameters may include an indication of a number of personnel available to perform maintenance (e.g., mowing) that day. In some situations, the number of available vehicles 10 may exceed the number of personnel available to operate the vehicles 10. If the number of personnel available is less than the number of available vehicles 10, the remote systems 240 may only generate route assignments for vehicles 10 that are staffed with an operator. In some embodiments, the desired mowing parameters identify each of the available personnel individually (e.g., by name, by employee number, etc.). In other embodiments, the desired mowing parameters indicate only a quantity of available personnel.

A golf course manager may utilize a user portal 230 to provide the desired mowing parameters. By way of example, the golf course manager may enter the desired mowing parameters directly (e.g., through a text field, by selecting available vehicles 10 from a list based on the mower data, etc.). By way of another example, the user portal 230 may include a graphical user interface showing the map 400, and the golf course manager may select zones to be mowed by clicking on the corresponding portions of the map 400. By way of another example, a golf course manager may predefine a schedule, and the desired mowing parameters may be selected according to the schedule. In one such example, the schedule predefines subsets of the zones that are to be mowed on recurring days (e.g., Mondays, Saturdays, etc.) or dates (e.g., the first of every month).

### Generating Route Assignments

In step 308 of the method 300, route assignments are generated for the vehicles 10 and the corresponding personnel. The route assignments may include both (a) a list of tasks to be performed by a vehicle 10 and/or the personnel along the route and (b) a path to be taken between the zones where the tasks are performed. The method 300 may facilitate selection of route assignments that minimize the total time required to perform maintenance of a golf course based on which vehicles 10 and personnel are available at the time.

The remote systems 240 may identify a group of vehicles 10 to be provided with route assignments based on the desired mowing parameters received in step 306, the course data, and/or the mower data. The desired mowing parameters may indicate (a) which zones should be mowed and/or raked, (b) which vehicles 10 are available to perform maintenance, and (c) a number of personnel available to operate the vehicles 10. Based on the available vehicles 10 and personnel, the remote systems 240 may identify which vehicles 10 may be assigned to complete maintenance of the desired zones.

The remote systems 240 may begin by using the course data to determine which types of zones are desired be mowed that day. The remote systems 240 may use the mower data to determine which types of zones are able to be mowed by the vehicles 10 that are available that day. By comparing the types of the desired zones to be mowed with the capabilities of the available vehicles 10, the remote systems 240 may determine whether an available vehicle 10 is capable of mowing at least one of the desired zones. If a vehicle 10 is incapable of mowing any of the desired zones, then the remote systems 240 may consider that vehicle 10 ineligible for a route assignment. Any of the vehicles 10 that are capable of mowing at least one of the desired zones may be considered eligible for a route assignment.

In a situation where the number of available personnel is greater than or equal to the number of available vehicles 10, all of the vehicles 10 may be operated simultaneously (e.g., without running out of operators). In such a situation, all of the eligible vehicles 10 may be provided with route assignments. Such a strategy may minimize the total time required to maintain the golf course by utilizing all available vehicles 10 simultaneously.

In a situation where the number of available personnel is less than the number of available vehicles 10, the remote systems 240 may select at least one of the available vehicles 10 to remain inactive (e.g., without a route assignment). In such a situation, the remote systems 240 may prioritize certain vehicles 10 when generating the route assignments. By way of example, the remote systems 240 provide route assignments to a subset of the available vehicles 10 that ensures all of the desired zones are capable of being mowed by at least one of the vehicles 10.

By way of example, if the desired zones include a green 406, the remote systems 240 may ensure that at least one of the vehicles 10 selected for route assignments is capable of mowing the green 406. By way of another example, if the desired zones include a relatively large number of greens 406 and a relatively small number of roughs 402, the remote systems 240 may prioritize the assignment of vehicles 10 that are capable of mowing the greens 406 over the assignment of vehicles 10 that are capable of mowing the roughs 402.

Once the group of vehicles 10 to be provided with route assignments has been selected, the remote systems 240 may generate sets of proposed route assignments for the vehicles 10. The remote systems 240 may generate multiple sets of proposed route assignments for later comparison against one another. The sets of proposed route assignments may be generated randomly, generated based on data available to the remote systems 240 (e.g., the course data), or generated based on other factors. Each set of proposed route assignments may include a route assignment for each of the vehicles 10, and the route assignments may be selected to ensure that every one of the desired zones is maintained.

By way of example, to generate a set of proposed route assignments, the remote systems 240 may distribute the desired zones amongst the vehicles 10, such that every vehicle 10 is assigned at least one zone. The remote systems 240 may then identify paths between the assigned zones. When generating the paths, the remote systems 240 may account for obstacles (e.g., a path crossing a water zone 412 may not be acceptable). The remote systems 240 may select the shortest possible path between the assigned zones for each vehicle 10. The route assignment for each vehicle 10 may include the selected paths, the assigned zones, and the tasks to be accomplished in each of the assigned zones.

For each route assignment within a set of proposed route assignments, the remote systems 240 may calculate a predicted completion time for the route based on the time prediction data.

The predicted completion time may be the sum of the total work time required to complete any assigned tasks, the total travel time required to travel between zones, and the total reconfiguration time required to reconfigure the vehicle 10.

The work time for mowing a zone may be predicted based on (a) which zone is being mowed, (b) which mowing pattern is selected for the zone, and (c) which vehicle 10 is performing the mowing. By way of example, the remote systems 240 may refer to the time prediction data generated in step 304 and select a predicted work time corresponding to the selected zone, mowing pattern, and vehicle 10. If the route assignment includes multiple tasks, a total work time may be calculated as the sum of the work times for each task.

The travel time for a selected path may be predicted based on (a) the length of the path, (b) the location of the path, and (c) which vehicle 10 is traveling along the path. By way of example, the remote systems 240 may refer to the time prediction data generated in step 304 and select a predicted travel time corresponding to the selected zone and path. By way of another example, the remote systems 240 may calculate the predicted travel time based on a predicted travel speed of the vehicle 10 and the length of the path. If the route assignment includes travel along multiple path segments, a total travel time may be calculated as the sum of the travel times for each path segments. The total travel time may account for (a) the travel time between an initial location of the vehicle and the zone of the first task and (b) the travel time between the zone of the last task and a desired final location of the vehicle 10 (e.g., a garage where the vehicles 10 are stored).

The reconfiguration time for a vehicle 10 may be predicted based on (a) the characteristics of the assigned zones (e.g., cutting height) and (b) which vehicle 10 is being adjusted. A vehicle 10 may be reconfigured, for example, when switching between a first type of zone having a first cutting height and a second type of zone having a second cutting height. By way of example, the remote systems 240 may refer to the time prediction data generated in step 304 and select a predicted reconfiguration time corresponding to the vehicle 10 and the type of reconfiguration being performed (e.g., raising or lowering a cutting deck). If the route assignment requires the vehicle 10 to be reconfigured multiple times, a total reconfiguration time may be calculated as the sum of the reconfiguration times for each change.

After calculating the predicted completion time for each of the route assignments, the remote systems 240 may calculate an overall predicted completion time for the set of route assignments. Specifically, the overall predicted completion time may be equal to the largest of the predicted completion times for the set of route assignments. By way of example, if the route assignment for a first vehicle 10 takes ten minutes, the route assignment for a second vehicle 10 takes twenty minutes, and the route assignment for a third vehicle 10 takes five minutes, then the overall predicted completion time would be twenty minutes, as this will be when the last vehicle 10 finishes its route assignment.

The remote systems 240 may compare the overall predicted completion times for each set of proposed route assignments and select the set of proposed route assignments having the lowest overall predicted completion time. By minimizing the overall predicted completion time, the maintenance of the golf course is completed as quickly as possible, freeing the golf course to be use by golfers. In some embodiments, the overall predicted completion time is minimized by selecting routes for each vehicle 10 having comparable predicted completion times. If the predicted completion times are approximately equal, the down time associated with each vehicle 10 is minimized.

### Providing Route Assignments

In step 310 of the method 300, a GUI is provided including one or more of the route assignments. Specifically, the GUI is used to notify each operator of each vehicle 10 of their corresponding route assignment. Separate GUIs may be provided for each route assignment (e.g., specific to each operator). Additionally or alternatively, a global GUI may be provided showing all of the route assignments simultaneously (e.g., on a job board, for a manager, etc.). The GUI may be provided through the user portal 230 of a user device. The user device may be a smartphone, tablet, or other dedicated device separate from the vehicles 10. Alternatively, the user device may be a screen onboard a vehicle 10.

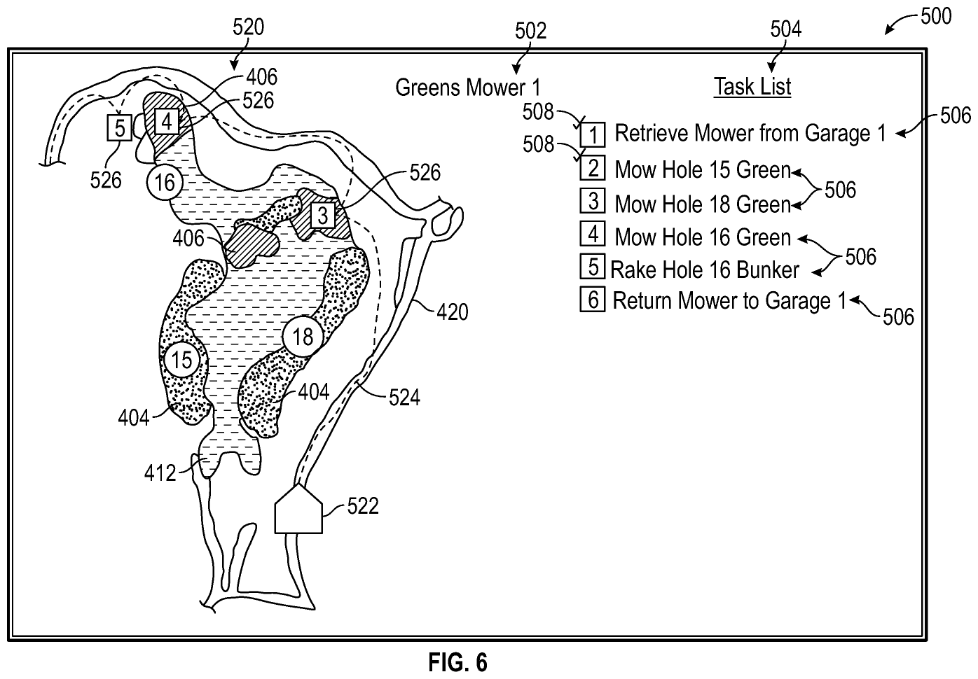

FIG. 6 illustrates a GUI 500 generated in step 310 according to an exemplary embodiment. As shown, the GUI 500 provides information specific to one operator and vehicle 10. In other embodiments, the GUI 500 includes information pertaining to multiple operators or multiple vehicles 10.

As shown, the GUI 500 includes a first zone or area, shown as identifier 502, identifying the vehicle 10 corresponding to the route assignment communicated through the GUI 500. As shown, the identifier 502 includes text stating “Greens Mower 1.” The identifier 502 both indicates a type of the vehicle 10 (i.e., the vehicle 10 is a greens mower) and identifies the vehicle 10 uniquely (e.g., the golf course may only have one “Greens Mower 1” but a different “Greens Mower 2”).

The GUI 500 further includes a second zone or area, shown as task list 504, that functions as a list of instructions to an operator of the vehicle 10. The task list 504 indicates a series of instructions, shown as task lines 506, each corresponding to a task included in the route assignment for the vehicle 10 associated with the GUI 500. Each task line 506 includes both (a) the task to be completed (e.g., retrieving a vehicle 10, mowing vegetation within a zone, raking sand within a zone, returning the vehicle 10 to a specific place, etc.) and (b) a location where the task will be performed (e.g., the green 406 of a particular hole, a specific bunker 510, a specific garage, etc.). The task list 504 may be organized (e.g., a spatial layout, using numerical indicators, etc.) to indicate the order in which the tasks should be performed.

The task list 504 further includes task completion indicators, shown as check marks 508, that indicate when a particular task has been completed. The check mark 508 may be placed next to a corresponding task line 506 when the task has been completed. In some embodiments, the remote systems 240 determine that a task has been completed based on data from the sensors 90. By way of example, the remote system 240 may determine that a task has been completed when the location data from the sensors 90 indicate that the vehicle 10 has exited a geofence associated with a zone where a task is to be performed. By way of another example, the remote system 240 may determine that a task has been completed when the sensors 90 indicate that a cutting element 84 has stopped spinning. In other embodiments, the operator interacts with the GUI 500 (e.g., by tapping a task line 506 on a touchscreen) to indicate when a task has been completed.

The GUI 500 further includes a third zone or area, shown as map 520, providing a graphical representation of the golf course. The map 520 may be a portion of the map 400 containing a current location of the vehicle 10. The map 520 includes a first visual indicator, shown as mower icon 522, indicating a current location of the vehicle 10. The mower icon 522 may also indicate the orientation or heading of the vehicle 10. The remote systems 240 may receive location data from the sensors 90 and update the position and orientation of the mower icon 522 in real time. Accordingly, an operator may use the map 520 to quickly, easily, and visually determine the location of the vehicle 10 relative to the golf course.

The map 520 further includes a second visual indicator, shown as path indicator 524, indicating a path corresponding to the route assignment. The path indicator 524 may represent the most efficient or otherwise most desirable route for the vehicle 10 to reach the next task of the route assignment. In some embodiments, the remote systems 240 update the path indicator 524 in real time based on the sensed location of the vehicle 10. By way of example, the path indicator 524 may reduce in length to visually indicate that the vehicle 10 has traveled along the desired path. By way of another example, the remote systems 240 may update the path indicator 524 to reflect the vehicle 10 straying from the desired path. In one such example, if the vehicle 10 travels east when the vehicle 10 should instead be traveling north, the path indicator 524 may move to the right to connect with the current location of the vehicle 10. Accordingly, the path indicator 524 may provide guidance to the operator that updates in real time to reflect the most efficient path.

The map 520 further includes a set of third visual indicators, shown as task indicators 526, indicating the locations of tasks to be performed on the golf course. The task indicators 526 may be numbered to indicate a correlation with the task lines 506. The task indicators 526 facilitate an operator determining where each task should be performed.

### Operate According to Route Assignments

In step 312 of the method 300, the operators operate the vehicles 10 according to the route assignments. Each operator may view the GUI 500 to determine how their corresponding vehicle 10 should be operated to complete the route assignment. When the last task of the route assignment has been completed, the remote systems 240 may determine that the route assignment is complete. When the last vehicle 10 finishes the corresponding route assignment, the remote systems 240 may determine that the maintenance of the golf course has concluded.

Throughout operation of the vehicles 10 in step 312, the sensors 90 of the vehicles 10 may continue to collect data regarding operation of the vehicles 10. This data may be used to further train the time prediction data as described in step 304. By continuously updating (e.g., adding to) the time prediction data, the accuracy of predicting the completion time of each route assignment may improve over time.

In some embodiments, one or more of the vehicles 10 is operated autonomously or semi-autonomously. By way of example, the operation of a vehicle 10 may be controlled partially or completely by the corresponding vehicle controller 100. In such an embodiment, the method 300 may be updated to provide the route assignments directly to the vehicle controllers 100 instead of to an operator through a GUI. The vehicle controller 100 may then autonomously control the vehicle 10 to complete the route assignment.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein. By way of example, a vehicle controller 100 may utilize both precision mowing and adaptive mowing.

1. A method of maintaining a golf course, the method comprising:
receiving course data identifying a plurality of zones within the golf course, the plurality of zones including a first zone, a second zone, and a third zone;
generating time prediction data for a plurality of mowers associated with the golf course, the time prediction data including a plurality of predicted work times, each predicted work time indicating a predicted amount of time required for one of the mowers to mow one of the zones;
receiving a set of desired mowing parameters indicating that a first mower and a second mower of the plurality of mowers are available for maintenance of the golf course;
generating a first route assignment for the first mower and a second route assignment for the second mower based on the course data and the time prediction data for the first mower and the second mower, wherein the first route assignment indicates that the first mower should mow the first zone and the second zone, and wherein the second route assignment indicates that the second mower should mow the third zone; and
providing a graphical user interface on a user device, the graphical user interface including instructions for an operator to complete the first route assignment using the first mower.

2. The method of claim 1, wherein the plurality of predicted work times includes a first predicted work time required for the first mower to mow the first zone, wherein generating the time prediction data includes calculating the first predicted work time based on an amount of time that the first mower previously required to mow the first zone.

3. The method of claim 1, wherein the time prediction data includes a predicted travel time required for the first mower to travel between the first zone and the second zone, and wherein generating the first route assignment and the second route assignment includes:
generating the first route assignment for the first mower and the second route assignment for the second mower based on the course data, the predicted work times for the first mower and the second mower, and the predicted travel time.

4. The method of claim 1, wherein the plurality of zones includes a fourth zone containing sand, wherein the time prediction data includes a predicted work time for a second operator of the second mower to rake the fourth zone, wherein the second route assignment indicates that the second operator of the second mower should rake the fourth zone, and wherein generating the first route assignment and the second route assignment includes:
generating the first route assignment for the first mower and the second route assignment for the second mower based on the course data, the time prediction data for the first mower and the second mower, and the predicted work time for the second operator of the second mower to rake the fourth zone.

5. The method of claim 1, wherein the first route assignment includes a path for the first mower to travel from the first zone to the second zone, and wherein the graphical user interface includes instructions for the first mower to follow the path.

6. The method of claim 5, wherein the graphical user interface includes a map illustrating a current location of the first mower relative to the second zone.

7. The method of claim 6, further comprising providing an updated graphical user interface on the user device in response to a determination that the first mower has moved off of the path, the updated graphical user interface including instructions for the first mower to follow an updated path from the current location to the second zone.

8. The method of claim 1, wherein the graphical user interface includes instructions for the operator to mow the first zone and subsequently mow the second zone.

9. The method of claim 1, wherein the first zone, the second zone, and the third zone are each at least one of a green, a fairway, a rough, or a tee box.

10. The method of claim 1, wherein the desired mowing parameters include a desired mowing pattern for the first zone, and wherein generating the first route assignment and the second route assignment includes:
generating the first route assignment for the first mower and the second route assignment for the second mower based on the course data, the time prediction data for the first mower and the second mower, and the desired mowing pattern for the first zone.

11. The method of claim 1, further comprising receiving compatibility data indicating at least one type of zone that the first mower is capable of mowing, and wherein generating the first route assignment and the second route assignment includes:
generating the first route assignment for the first mower and the second route assignment for the second mower based on the course data, the time prediction data for the first mower and the second mower, and the compatibility data.

12. The method of claim 1, wherein the course data includes map data defining boundaries of the first zone, the second zone, and the third zone.

13. A method of maintaining a golf course, the method comprising:
receiving course data identifying a plurality of zones within the golf course, the plurality of zones including a first zone and a second zone;
generating time prediction data for a plurality of mowers associated with the golf course, the time prediction data including a plurality of predicted travel times, each predicted travel time indicating a predicted amount of time required for one of the mowers to travel between two of the zones;
generating a route assignment for a first mower of the plurality of mowers based on the course data and the time prediction data for the first mower, wherein the route assignment indicates that the first mower should mow the first zone and the second zone; and
providing a graphical user interface on a user device, the graphical user interface including instructions for an operator to complete the route assignment using the first mower.

14. The method of claim 13, wherein the route assignment is a first route assignment, further comprising generating a second route assignment for a second mower of the plurality of mowers based on the course data and the time prediction data for the second mower, wherein the second route assignment indicates that the second mower should mow a third zone and a fourth zone of the plurality of zones.

15. The method of claim 13, wherein the graphical user interface includes a visual representation of a path from the first zone to the second zone.

16. A golf course management system comprising:
a first mower;
a second mower;
a user device; and
a non-transitory computer-readable medium having instructions stored thereon that, when executed by one or more processors, cause the one or more processors to:
receive course data identifying a plurality of zones within a golf course, the plurality of zones including a first zone, a second zone, and a third zone;
generate time prediction data including a plurality of predicted work times, each predicted work time indicating a predicted amount of time required for the first mower or the second mower to mow one of the zones;
generate a first route assignment for the first mower and a second route assignment for the second mower based on the course data and the time prediction data, wherein the first route assignment indicates that the first mower should mow the first zone and the second zone, and wherein the second route assignment indicates that the second mower should mow the third zone; and
control the user device to provide a graphical user interface including instructions for an operator of the first mower to complete the first route assignment.

17. The golf course management system of claim 16, wherein the time prediction data includes a predicted travel time required for the first mower to travel between the first zone and the second zone, and wherein the instructions cause the one or more processors to generate the first route assignment for the first mower and the second route assignment for the second mower based on the course data, the predicted work times for the first mower and the second mower, and the predicted travel time.

18. The golf course management system of claim 16, wherein the instructions cause the one or more processors to:
receive a desired mowing pattern for the first zone and a desired mowing pattern for the second zone; and
generate the first route assignment for the first mower and the second route assignment for the second mower based on the course data, the time prediction data, the desired mowing pattern for the first zone, and the desired mowing pattern for the second zone.

19. The golf course management system of claim 16, wherein the instructions cause the one or more processors to:
receive compatibility data indicating at least one type of zone that the first mower is capable of mowing and at least one type of zone that the second mower is incapable of mowing; and
generate the first route assignment for the first mower and the second route assignment for the second mower based on the course data, the time prediction data, and the compatibility data.

20. The golf course management system of claim 16, wherein the user device includes a display coupled to the first mower.
